(19) United States
(12) Patent Application Publication
(10) Pub. No.: US 2026/0279025 A1
(43) Pub. Date: Sep. 17, 2026

(54) OPTIMIZING RECOGNITION ACCURACY BY THIN LINE SEGMENTATION MODELS USING INTERSECTION OVER LENGTH

(71) Applicant: FNV IP B.V., Leidschendam (NL)

(72) Inventors: Anmol Sharan NAGI, Leidschendam (NL); Harshpal SINGH, Leidschendam (NL); Marcus NEPVEAUX, Leidschendam (NL)

(73) Assignee: FNV IP B.V., Leidschendam (NL)

(21) Appl. No.: 19/472,864

(22) PCT Filed: Apr. 24, 2024
(86) PCT No.: PCT/EP2024/061299

§ 371 Date: Oct. 6, 2025

Related U.S. Application Data
(60) Provisional application No. 63/463,229, filed on May 1, 2023.

(51) Int. Cl. G06V 10/776; G06V 10/26; G06V 10/34; G06V 10/82; G06V 10/86; G06V 20/50

(52) U.S. Cl. CPC G06V 10/776; G06V 10/26; G06V 10/34; G06V 10/82; G06V 10/86; G06V 20/50

(57) ABSTRACT

The present technology provides solutions for optimizing object recognition by models by using intersection over length. An example method includes receiving a set of manually labeled polylines and a prediction mask produced by a model for an image, skeletonizing the prediction masks to obtain prediction polylines for the image, augmenting the manually labeled polylines with a buffer along a length of the manually labeled polylines, portraying the manually labeled polylines with the buffer as a ground truth graph, projecting each segment of the prediction polylines onto the ground truth graph, determining detection intervals between the manually labeled polylines with the buffer and the prediction polylines, and computing an accuracy of the model for each segment of the crack. Unlocking insights from Geo-Data, the present invention further relates to improvements in sustainability and environmental developments: together we create a safe and liveable world.

### TECHNICAL FIELD

The present disclosure generally relates to image segmentation tasks associated with one or more machine learning networks (e.g., neural networks, etc.). For example, aspects of the present disclosure are related to systems and techniques for performing thin line segmentation using intersection-over-length (IOL) information. Unlocking insights from Geo-Data, the present invention further relates to improvements in sustainability and environmental developments: together we create a safe and liveable world.

### BACKGROUND

Fully automated, highly accurate pavement distress detection from 2D and/or 3D pavement imaging systems has been a challenge in the pavement management industry. Advancements in computer vision have facilitated training of image segmentation models at scale for detecting objects of various shapes and sizes. To train such models, acquiring high quality pixel perfect crack labels is required, but not feasible at scale. In day-to-day practice, manual annotations cover a general trend of cracks.

Additionally, these models are evaluated using performance metrics, such as mean intersection over union. In other words, these models are evaluated based on the amount of intersection between predictions and manually labeled data in relation to the total amount of area (i.e., union) of the predictions and the manually labeled data. These metrics are inefficient and provide a biased view of the outcome.

### BRIEF SUMMARY

In one aspect, a method includes receiving a set of manually labeled polylines and a prediction mask produced by a model for an image, where the manually labeled polylines are associated with a general trend of a crack in the image, and where the prediction mask is associated with detection of the crack, skeletonizing the prediction masks to obtain prediction polylines for the image, augmenting the manually labeled polylines with a buffer along a length of the manually labeled polylines, where the buffer provides a tolerance region to compensate for imperfections in manual labels of the manually labeled polylines, portraying the manually labeled polylines with the buffer as a graph with edges and nodes, where each edge is a polyline and each node is a location where the one or more polylines meet or diverge, projecting each segment of the prediction polylines onto the graph with edges and nodes, determining detection intervals between the manually labeled polylines with the buffer and the prediction polylines, where the detection intervals are the start and end points of the projections of prediction polylines onto the manual polyline within the buffer, and computing an accuracy of the model for each segment of the crack, where the accuracy is an intersection over length calculation based on the detection interval and the length of a respective segment of the manually labeled polylines.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 illustrates an example implementation of a system-on-a-chip (SoC), according to some aspects of the disclosed technology;

FIG. 2 illustrates an example of a deep learning neural network that can be used to implement a perception module and/or one or more validation modules, according to some aspects of the disclosed technology;

FIG. 3 illustrates examples of an unannotated image, a manually annotated image, model prediction of the image, and an image having manual annotations and model predictions, according to some aspects of the disclosed technology;

FIG. 4 illustrates an example image including overlapping detection intervals between manual annotations and model predictions, according to some aspects of the disclosed technology;

FIG. 5 illustrates example unannotated images, manually annotated images, model predictions for the images, and images including overlapping detection intervals between manual annotations and model predictions, according to some aspects of the disclosed technology;

FIG. 6A illustrates an example algorithm for determining accuracy by a model, according to some aspects of the disclosed technology;

FIG. 6B illustrates a further example of an Intersection over Length (IoL)-based approach for determining accuracy by a model (e.g., a thin line segmentation model), according to some aspects of the disclosed technology;

FIG. 7 illustrates an example method for optimizing recognition accuracy by a model, according to some aspects of the disclosed technology;

FIG. 8 illustrates an example method for training a machine learning model, according to some aspects of the disclosed technology; and

FIG. 9 shows an example of a system for implementing certain aspects of the disclosed technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Traditional machine learning metrics demand accurate labels to calculate metrics, such as mean average precision, intersection over union (IoU), F1 score, etc., for image segmentation tasks. However, these metrics are unable to give a proper context of the machine learning algorithm's applicability when labels are imprecise, inaccurate, and/or unavailable. For example, in the context of machine learning models (e.g., also referred to herein as “machine learning networks”) used to perform a thin line segmentation task for purposes that may include, but are not limited to, thin line segmentation for crack detection and/or prediction, human labelers traditionally provide manual annotations of cracks that may be imprecise, inaccurate, and/or unavailable. For instance, a thin line segmentation model for crack detection and/or prediction can be trained using labeled training data that comprises images of cracks (e.g., in a roadway surface or other physical surface) that have been manually annotated by human labelers. Human labelers traditionally provide manual annotations (e.g., labels) indicative of a general trend of a crack in an image, rather than a pixel-perfect annotation of the crack. As such, annotations that are indicative of a general trend of a crack in an image can be seen to be imprecise and/or inaccurate as compared to an actual ground-truth representation of the crack (e.g., the “pixel-perfect” annotation of the crack). These imprecisions in the labeled training data can cause measurement issues downstream, for instance when a machine learning model (e.g., thin line segmentation model) is implemented based on training that utilizes the imprecise and imperfect labeled training data.

For example, current machine learning models may be trained based on metrics that typically utilize (e.g., for segmentation models) mean intersection over union (mIoU) as a metric to determine the accuracy of the model. Mean intersection over union is calculated as the area of intersection (A_{intersection}) between the model prediction and the ground truth, divided by the area of union (Aᵤₙᵢₒₙ) between the model prediction and the ground truth. For instance, the area of intersection, A_{intersection}, can be determined as the overlap between a prediction of the model for a given training data input and the corresponding “ground-truth” provided by the manually labeled annotations associated with the given training data input. The area of union, Aᵤₙᵢₒₙ, can be determined as the combined area encompassed by the combination of the area of prediction and the ground truth. However, mean intersection over union can be an imperfect metric to determine the accuracy of the model.

More specifically, mean intersection over union is a generally strong metric for larger, blob-like objects because there is often a significantly higher intersection to union ratio (e.g., the area of intersection between the model prediction and the ground truth represents a relatively large percentage of the total/combined area of union). However, mean intersection over union is often a poor metric for smaller and/or thinner objects. For example, mean intersection over union is an unreliable metric for thin line segmentation models, such as models that annotate cracks in pavement. In such examples, the area of intersection between a model prediction of the thin-line crack and the ground truth annotation of the thin-line crack may be very small relative to the combined area of the predicted crack and the ground truth crack. In such cases, the mIoU metric may provide small values that are less useful for training purposes, based on the mIoU denominator being significantly greater than the mIoU numerator (e.g., because for thin-line segmentation examples, Aᵤₙᵢₒₙ>>A_{intersection}).

In general, mean intersection over union can fail to account for human error and/or imprecisions that may be present in the ground truth annotation information that is used in computing both A_{intersection} and Aᵤₙᵢₒₙ. As such, mIoU that is calculated for a machine learning model being trained on imperfectly labeled training data can result in a biased training metric and a trained model having reduced accuracy and/or performance at the thin-line segmentation task.

As noted previously, the issues associated with implementing training based on mIoU (e.g., using an mIoU-based loss) can be particularly important for recognition of thinner objects because the intersection to union ratio can often be much smaller, especially for non-coincident polylines. For example, when the manual annotations are inaccurate and the model prediction is in agreement with the (inaccurate) manual annotations, evaluation of the model output based on mIoU would indicate a high accuracy, because the model output closely matches or corresponds to the inaccurate “ground truth” annotation/label. In other words, training based on mIoU can be seen to be highly dependent upon the accuracy of the annotations or labels that are treated as ground truth information during the training process. Similarly, when the manual annotations are inaccurate and the model prediction is accurate (e.g., the model detects the actual position of the polylines, such as cracks), mIoU-based evaluation or training approaches may indicate a low accuracy, despite the model predictions being accurate.

Since models are trained and evaluated based on these unreliable metrics, there is a need in the art for a robust metric for computing accuracy of thin line segmentation models. Accordingly, the present technology addresses this need in the art by providing intersection over length (IoL) as a robust metric for computing accuracy of thin line segmentation models. Utilizing an intersection over length algorithm can provide better context for the training of thin line segmentation models, for instance based on IoL being better suited to evaluating model performance on loosely labeled, non-linear features, etc.

In the context of roads and pavement, these loosely labeled features can be road cracks or cracks in the pavement (among various other surfaces that may be subject to cracking or otherwise include visual thin-line features of interest). It is difficult to manually draw pixel perfect labels of cracks when generating the ground truth labeled training data for training a crack-detection model (i.e., a type of thin line segmentation model), whereas drawing a rough line over a crack is easy and efficient (but produces inaccurate “ground truth” training data labels). However, as discussed above, the model will detect the actual position of the crack in the input training image, and will evaluate poorly under the mIoU metric because the actual position of the crack is inaccurately represented in the ground truth labeling for the training image.

The presently disclosed intersection over length (IoL)-based approach can be seen to better measure the absolute coverage of the actual crack by the model prediction. More specifically, the systems and techniques described herein can implement an IoL-based approach by buffering the manually labeled polylines of the cracks (e.g., also referred to herein as “ground truth polylines” or “labeled polylines”). Buffering the labeled polylines can comprise adding one or more pixels on one (or both) sides of the labeled polylines, thereby increasing the area corresponding to the ground-truth location of the crack.

The one or more pixels added on either side of a labeled polyline can be seen to act as a buffer or tolerance region to compensate for imperfect line labels. In some cases, the quantity of pixels added on either side of a labeled polyline can be referred to as a “buffer parameter” or a “tolerance parameter.” In some aspects, the addition of one or more buffer pixels on either side of a polyline can be based on the labeled polyline (i.e., corresponding to a crack) having a width of one pixel. In another illustrative example, a quantity of pixels can be added or buffered on either side of a labeled polyline to create a buffered polygonal area having a buffered area (on either side of the polyline) with a width that is an integer multiple of the width of the labeled polyline itself. For instance, the width of the buffered area added on either side of a polyline can be greater than or equal to the width of the labeled polyline itself. In some examples, the buffered area can be the same on both sides of a labeled polyline. In another example, the buffered area added adjacent to a first side of the labeled polyline can be larger or smaller than the buffered area added adjacent to the second side of the labeled polyline, etc.

By buffering the labeled polylines to create a buffered polygon or buffered polygon area (an area which includes the entirety of the underlying, labeled polyline), the predictions of the thin-line segmentation model are subsequently projected onto the ground truth line within the buffer region to obtain the length of coverage of the ground truth line by the prediction mask. In some embodiments, the ground truth polylines are dissected into individual segments, such that each segment is an edge of a graph and each location where the cracks either converge or diverge is a node of the graph. As the model detects segments, the algorithm will determine the intersection between the model predictions and the edges of the graphs. The algorithm can then determine the accuracy of the model by calculating the detected length (e.g., detected length of intersection) for a particular segment or edge in relation to the total length of that particular segment or edge. The algorithm can then aggregate the value indicative of the accuracy of the model for that particular segment with other values for other respective segments to determine an overall accuracy of the model for the image. In some embodiments, the accuracy values can be weighted based on the length of the respective segments.

The presently disclosed intersection over length (IoL)-based approach can be used to measure, determine, and/or review model predictions generated by a machine learning model (e.g., such as a thin-line segmentation model). In some embodiments, with appropriate modifications the presently disclosed IoL metric can be used to implement various loss functions for training and/or re-training the machine learning model (e.g., training or re-training the thin-line segmentation model). For instance, the IoL metric can be used to implement one or more loss functions that replace traditional loss functions used in training (e.g., mIoU, Dice loss, etc.). Additionally, or alternatively, the IoL metric can be used to implement one or more loss functions that are combined (e.g., used to augment or otherwise used in combination with) one or more traditional loss functions for training the machine learning model. In one illustrative example, a machine learning model (e.g., thin-line segmentation model) can be trained using the presently disclosed IoL metric based on using the IoL-based loss to adjust one or more model intrinsic weights during the training process. In this manner, more accurate predictions are encouraged if the IoL-based loss decreases. Training can continue based on the one or more IoL-based loss functions for one or more rounds. Based on the IoL-based loss converging to a minimum value, the training can conclude.

Various aspects of the present disclosure will be described below with respect to the figures.

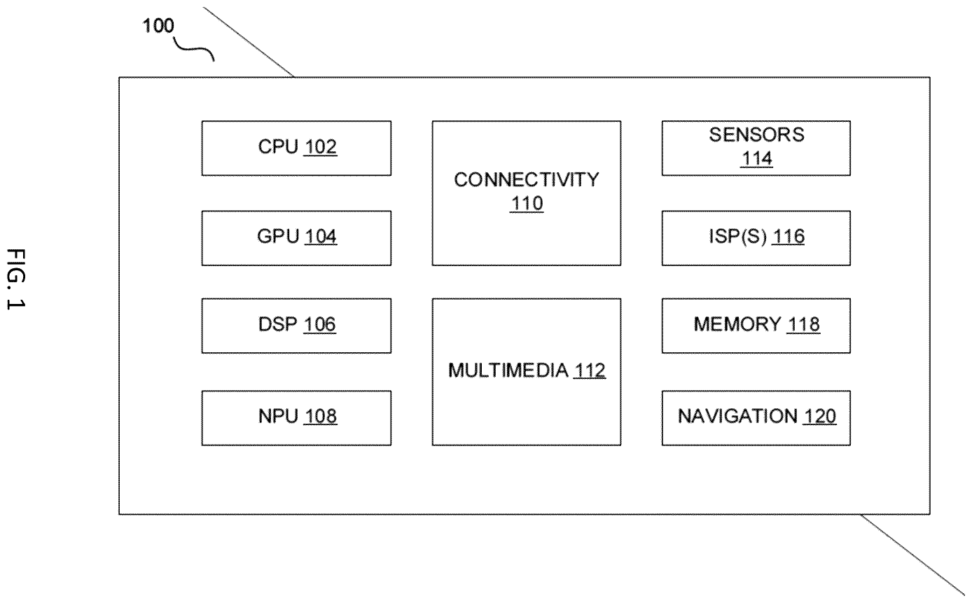

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof may be configured to perform image processing using machine learning techniques according to aspects of the present disclosure discussed herein. For example, SOC 100 and/or components thereof may be configured to perform semantic image segmentation according to aspects of the present disclosure. In some cases, by using neural network architectures such as transformers and/or shifted window transformers in determining one or more segmentation masks, aspects of the present disclosure can increase the accuracy and efficiency of semantic image segmentation.

In general, ML can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

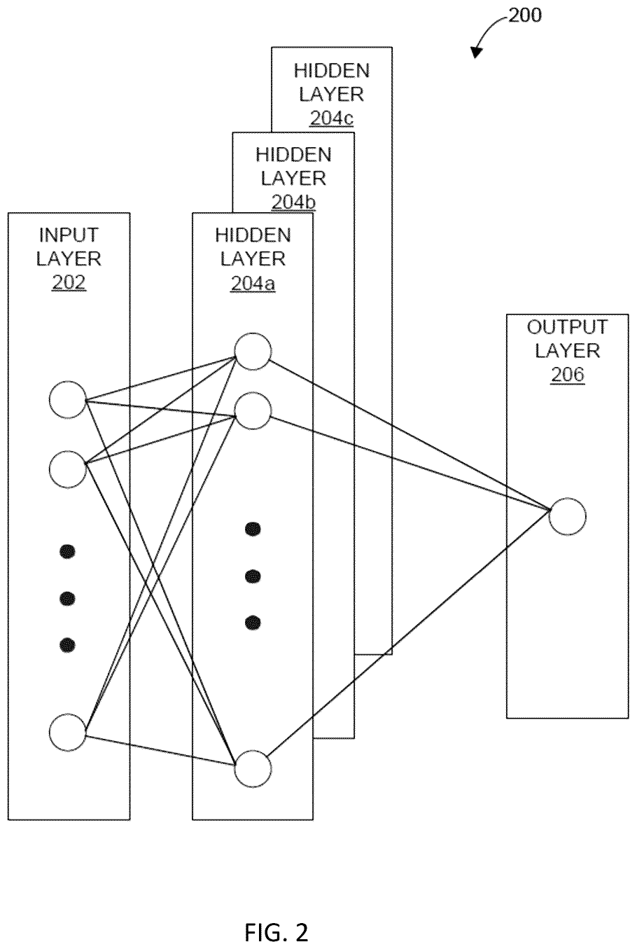

In FIG. 2, the disclosure now turns to a further discussion of models that can be used through the environments and techniques described herein. Specifically, FIG. 2 is an illustrative example of a deep learning neural network 200 that can be used to implement all or a portion of a perception module (or perception system) as discussed above. An input layer 202 can be configured to receive sensor data and/or data relating to an environment surrounding an AV. The neural network 200 includes multiple hidden layers 204a, 204b, through 204c. The hidden layers 204a through 204c include “n” number of hidden layers, where “n” is an integer greater than or equal to one. The number of hidden layers can be made to include as many layers as needed for the given application. The neural network 200 further includes an output layer 206 that provides an output resulting from the processing performed by the hidden layers 204a through 204c. In one illustrative example, the output layer 206 can provide estimated treatment parameters, that can be used/ingested by a differential simulator to estimate a patient treatment outcome.

The neural network 200 is a multi-layer neural network of interconnected nodes. Each node can represent a piece of information. Information associated with the nodes is shared among the different layers and each layer retains information as information is processed. In some cases, the neural network 200 can include a feed-forward network, in which case there are no feedback connections where outputs of the network are fed back into itself. In some cases, the neural network 200 can include a recurrent neural network, which can have loops that allow information to be carried across nodes while reading in input.

Information can be exchanged between nodes through node-to-node interconnections between the various layers. Nodes of the input layer 202 can activate a set of nodes in the first hidden layer 204a. For example, as shown, each of the input nodes of the input layer 202 is connected to each of the nodes of the first hidden layer 204a. The nodes of the first hidden layer 204a can transform the information of each input node by applying activation functions to the input node information. The information derived from the transformation can then be passed to and can activate the nodes of the next hidden layer 204b, which can perform their own designated functions. Example functions include convolutional, up-sampling, data transformation, and/or any other suitable functions. The output of the hidden layer 204b can then activate nodes of the next hidden layer, and so on. The output of the last hidden layer 204c can activate one or more nodes of the output layer 206, at which an output is provided. In some cases, while nodes in the neural network 200 are shown as having multiple output lines, a node can have a single output and all lines shown as being output from a node represent the same output value.

In some cases, each node or interconnection between nodes can have a weight that is a set of parameters derived from the training of the neural network 200. Once the neural network 200 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 200 to be adaptive to inputs and able to learn as more and more data is processed.

The neural network 200 is pre-trained to process the features from the data in the input layer 202 using the different hidden layers 204a through 204c in order to provide the output through the output layer 206.

In some cases, the neural network 200 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 200 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 200 can perform a backward pass by determining which inputs (weights) most contributed to the loss of the network, and can adjust the weights so that the loss decreases and is eventually minimized.

The neural network 200 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 200 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

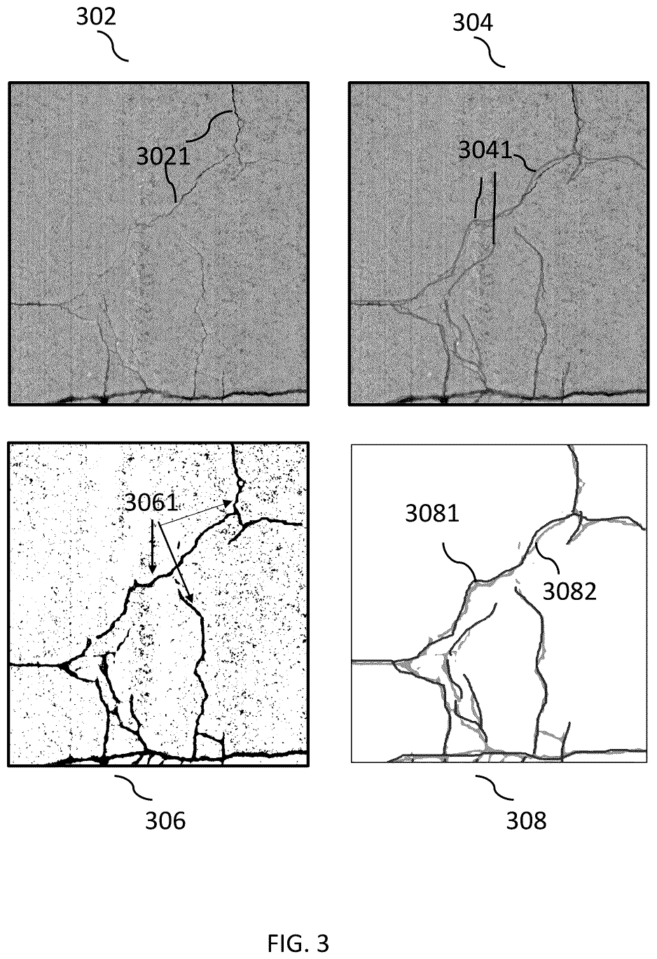

FIG. 3 illustrates an image 302 that includes cracks 3021 in a pavement. In some aspects, the image 302 can be a depth encoded image. Image 304 illustrates image 302 with manual annotations (e.g., labeled by a human) shown in lighter gray with triangles 3041. These manual annotations are often strong indicators of the general trend of the cracks, but may be imprecise at a granular (e.g., pixel) level. In other words, these manual annotations are often not pixel perfect and may generally be accurate but may be imprecise.

Image 306 illustrates image 302 with model predictions (e.g., generated by a thin-line segmentation machine learning model) identifying detection of the cracks, which are indicated by lines 3061. The models are often highly precise and are capable of identifying cracks down to a pixel perfect level. Indeed, a comparison between the model prediction output seen in image 306 to the actual crack locations in the input image 302 illustrates that the thin-line segmentation model is capable of generating predicted outputs that reliably detect and/or identify the cracks present in the input image 302.

Image 308 illustrates image 302 with both the manual annotations of image 304 with cracks in darker gray 3081 the model predictions of image 306 with cracks in lighter gray 3082. Image 308 demonstrates that the manual annotations (in darker gray) and the model predictions (in light brayer) are often not perfectly aligned. Thus, a mean intersection over union metric would have a relatively low value (e.g., closer to 0 than 1) due to the low area of intersection between the lighter gray manual annotations and the darker gray prediction, and further due to the large area of union between the combination of the lighter gray manual annotations and the darker gray model predictions.

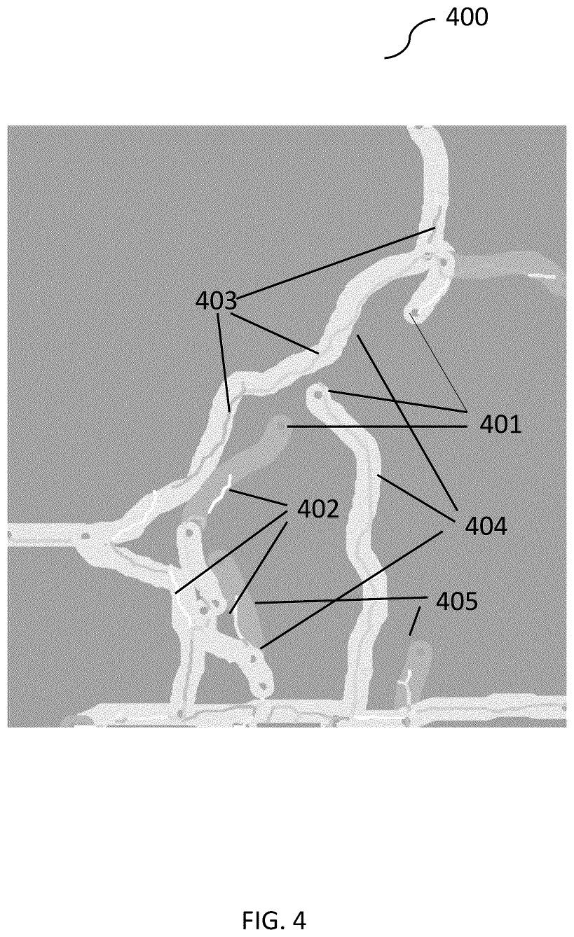

FIG. 4 illustrates values determined by an intersection over length algorithm. More specifically, image 400 illustrates image 302 with manual annotations (e.g., polylines) augmented with a buffer area. Image 400 further identifies overlapping detections between the manual annotations and model predictions. The manual annotations are portrayed as a graph, such that locations of convergence and/or divergence of cracks are nodes of the graph (shown as dots 401), and the edges between the nodes of the graph are each representative of a corresponding crack. The model predictions (e.g., prediction polylines corresponding to crack locations as determined by the thin line segmentation model) are depicted as thin lines that are in white 402 or gray 403 individually. The branches of the graph are depicted as the thicker gray 405 or white 404 line segments that are wider than the model prediction polylines. Each gray or white branch corresponds to a manual annotation polyline augmented with a buffer area (e.g., for instance, the increased width of the white or gray branches relative to the individually colored thin lines corresponding to the model prediction polylines can be representative of the increased buffer area utilized). In one illustrative example, “detected” branches of the graph are shown as the white branches, while “missed” or “missed detection” branches of the graph are shown as the gray branches.

In particular, the thick white line segments 404 corresponding to the detected branches are indicative of a predicted crack location generated by the thin line segmentation model that is within the buffered area and has a sufficient intersection over length (IoL) coverage of the manual annotations/polylines. In other words, the white detected branches indicate that the thin, polyline corresponding to the model prediction is located within the buffered area of the corresponding manual annotation polyline over a percentage of its length that is greater than or equal to a pre-determined threshold (e.g., for instance, a white detected branch can indicate that the model prediction polyline is within the expanded manual annotation buffer area for at least 75% of the model prediction polyline's length, etc.) The model prediction output may miss or fail to detect some portions associated with some manual annotations, which will result in the model prediction polyline overlapping with (e.g., being located within) the expanded buffer area of the corresponding manual annotation polyline over a percentage of its length that is less than the pre-determined threshold (e.g., for instance, a gray missed detection branch can indicate that the model prediction polyline is not within the buffer area of the manual annotation polyline for at least 75% of the model prediction polyline's length). In some cases, a gray missed detection branch may indicate no overlap or an intersection percentage of 0.

As further illustrated in FIG. 4, image 400 includes a significant amount of overlapping detections in comparison to missed portions. In other words, the model predictions are highly accurate. More specifically, the intersection over length metric associated with the white detected branches and the gray missed branches indicates that the thin line segmentation model predictions are highly accurate. However, as discussed above with respect to FIG. 3, image 308 illustrates that accuracy of the model is low when utilizing a mean intersection over union algorithm instead.

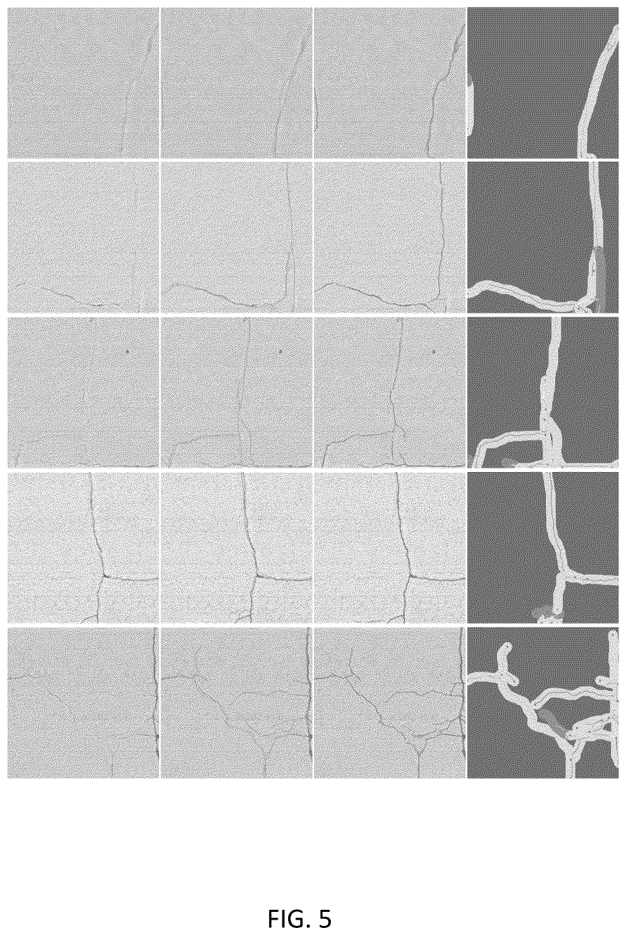

FIG. 5 illustrates various examples of other unannotated images (e.g., the left-most column comprising five rows/five different unannotated images); manually annotated images (e.g., the second from left column comprising five rows/five different manually annotated images each corresponding to the input image of the same row); thin line segmentation model predictions for the input images (e.g., the third from left column comprising five rows/five different thin line segmentation model predictions each corresponding to a prediction for the input image of the same row); and the overlapping IoL detection intervals between the manual annotations and the model predictions (e.g., the right-most column comprising five rows/five different overlapping IoL detection interval images each corresponding to the manual annotation and model prediction of the same row).

As can be observed from FIG. 5 that model predictions are more accurate than the manual annotations. It is evident from below Table 1 that in case mIOU is used as a success metric then the model is able to correctly label only 20% of the manually annotated pixels. Whereas IOL provides us a more holistic view of the model's accuracy. In our experiments it is observed that IOL metric is a better indicator of crack-line segmentation model's performance.

TABLE 1

| Index | mIOU (%) | IOL (%) |
|---|---|---|
| 1 | 19.6 | 87.6 |
| 2 | 21.8 | 83.1 |
| 3 | 16.6 | 87.7 |
| 4 | 25.5 | 89.3 |
| 5 | 25.1 | 91.9 |
| Mean | 21.7 | |

As indicated by Table 1, a mean intersection over union (mIoU)-based approach consistently underreports the accuracy of the thin line segmentation model, such that the accuracy is often identified at approximately 25% or lower. In contrast, the presently disclosed intersection over length (IoL)-based approach provides a more holistic view of the model's accuracy, such that the accuracy is often identified at over 80%.

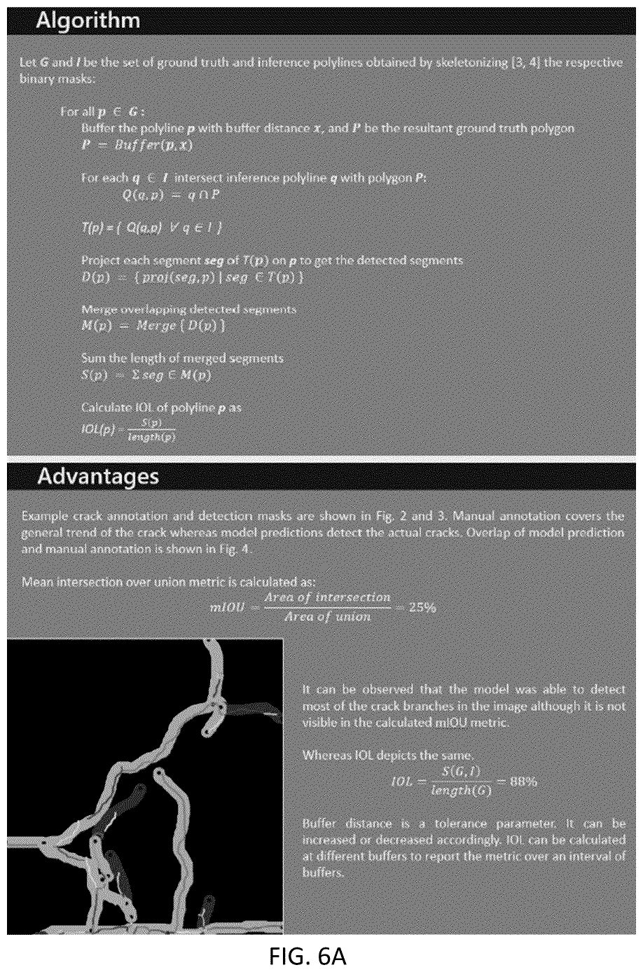

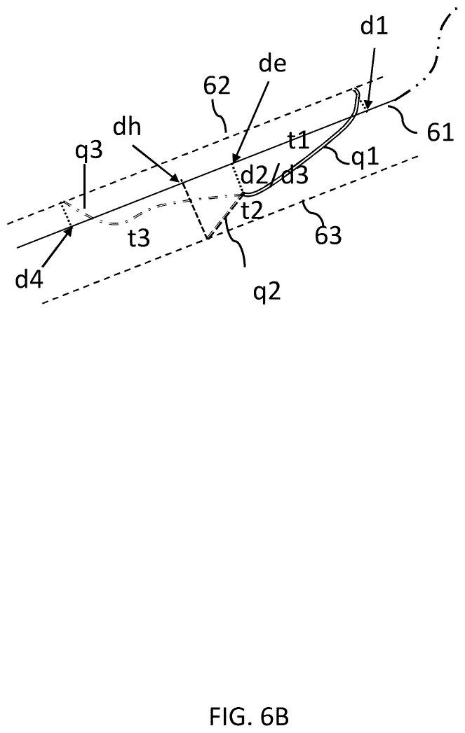

FIG. 6A illustrates an example algorithm for optimizing recognition accuracy by a model (e.g., thin line segmentation machine learning model) based on utilizing an intersection over length (IoL)-based approach. Additionally, FIG. 6A identifies formulas and calculations to determine accuracy of mean intersection over union and intersection over length.

FIG. 6B illustrates another example corresponding to an IoL-based algorithm for optimizing recognition accuracy associated with a model (e.g., a thin line segmentation machine learning model and/or a crack detection and identification machine learning model, etc.). Described below is an example of the IoL-based algorithm. With reference to FIG. 6B, the double line represents a first prediction polyline q₁; the double dashed line represents a second prediction polyline q₂; and the double dash-dotted line represents a third prediction polyline q₃. The solid line 61 represents a labeled/manually annotated ground truth polyline. The upper and lower dashed lines 62 and 63 (i.e., approximately parallel to the solid line, ground truth polyline) represent the upper and lower boundaries, respectively, of the buffer polygon determined for the solid line, ground truth polyline label.

As described above, the solid line 61 represents a labeled/manually annotated ground truth polyline. Segment t1 is portion of q1 that is contained within the tolerance zone (dashed lines 62 and 63). Similarly, segments t2 of q2 and t3 of q3 are within the tolerance zone. Points d1 and d2 are projections of t1 on p1. Similarly, d3, d4 are projections of t3 and de, dh are projections of t2 on p1.

Iol is computed by accumulating all the projections of prediction segments that lie within the tolerance zone and dividing by the length of the ground truth line segment. It is important to note that while accumulating the algorithm should not double count the overlapping projections e.g. in this case segment dh, de. Hence the IoL=Length(d1, d4)/Length(p1)

In one illustrative example, the IoL-based algorithm can be implemented as described below.

Let G and I be the set of ground truth and inference polylines, respectively, obtained by skeletonizing the respective binary masks. The skeleton is a graph with a set of nodes and edges of point coordinates in the binary mask. Each edge of this graph is a polyline in the set G or I. The edges belonging to ground truth binary masks are added to the set G and the edges determined as a thin line segmentation model prediction (e.g., the edges from inference) are added to I. The edges in the set G correspond to ground truth polylines provided as manual annotations/labels for the locations of cracks (or other thin line features) in an input training image. The edges in the set I correspond to predicted polylines generated by a thin line segmentation model used to predict the locations of cracks (or other thin line features) in the input training image.

For all p∈G:
Buffer the polyline p with a buffer distance x and let P be the resultant ground truth polygon. For instance, the solid polyline p in FIG. 6B can be buffered using a buffer distance of x (e.g., x pixels on either side of the solid polyline p):

$$P = Buffer ( p , x )$$

Extract valid inference segments by performing a geometric intersection of each inference polyline q(q∈I) and the buffered ground truth polygon P. The result will be another set of polylines i.e., for each q∈I, intersect inference polyline q with polygon P:

$$Q ( q , p ) = q ∩ P$$

$$T ( p ) = \{ Q ( q , p ) ∀ q ∈ I \}$$

Project each segment seg of T(p) (e.g., project end points of polyline t∈T(p) on p) to get the detected segments D(p) along p:

$$D ( p ) = \{ proj ( seg , p ) \vert seg ∈ T ( p ) \}$$

When a point is projected onto a polyline p, we obtain a pixel distance from either end of p. Hence a detected segment D(p) can be a tuple of distance values along p.

The detected segments can be potentially overlapping since while intersecting the buffered polygon P with the inference polylines I, we may capture segments of nearby detections q′∈I corresponding to a polyline p′∈G very close to p. To prevent overestimation of detection coverage of polyline p, we need to merge these detected segments, such that if there exist two detected segments D1=(d1, d2) and D2=(d3, d4), where d2>=d3, then: Merge(D1, D2)=D3=(min(d1, d3), max(d2,d4)).
Merge overlapping detected segments:

$$M ( p ) = Merge \{ D ( p ) \}$$

Sum the length of merged segments to get the total detected length of p:

$$S ( p ) = \sum seg ( m ) ∀ m ∈ M ( p ) , where seg ( m ) = m ( d 2 ) - m ( d 1 )$$

Now, IoL can be calculated for the polyline p by dividing the summed length of all merged segments (i.e., the sum S(p)) by the length of the polyline p:

$$I O L ( p ) = \frac{d 4 - d 1}{length ( p )}$$

Where length(p)=Length of polyline p.

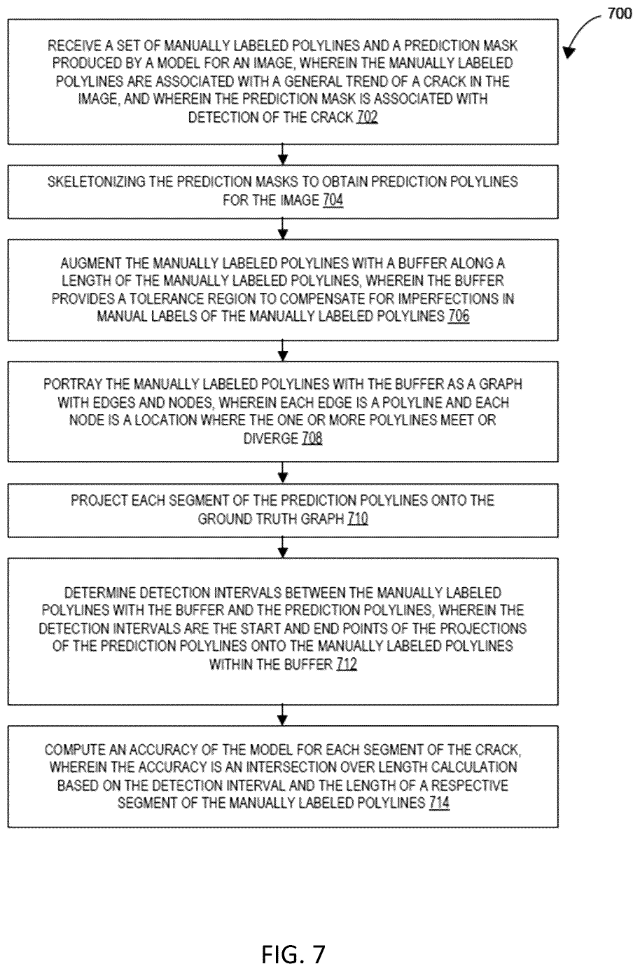

FIG. 7 illustrates an example method 700 for optimizing recognition accuracy by a model by utilizing intersection over length. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

In step 702, method 700 receives a set of manually labeled polylines and a prediction mask produced by a model for an image, wherein the manually labeled polylines are associated with a general trend of a crack in the image, and wherein the prediction mask is associated with detection of the crack.

In step 704, method 700 skeletonizing the prediction masks to obtain prediction polylines for the image.

In step 706, method 700 augments the manually labeled polylines with a buffer along a length of the manually labeled polylines, wherein the buffer provides a tolerance region to compensate for imperfections in manual labels of the manually labeled polylines.

In step 708, method 700 portrays the manually labeled polylines with the buffer as a ground truth graph, wherein each edge of the ground truth graph is a polyline and each node of the ground truth graph is a location where the one or more polylines meet or diverge.

In step 710, method 700 projects each segment of the prediction polylines onto the ground truth graph

In step 712, method 700 determines detection intervals between the manually labeled polylines with the buffer and the prediction polylines, wherein the detection intervals are the start and end points of the projections of prediction polylines onto the manually labeled polyline within the buffer.

In step 714, method 700 computes an accuracy of the model for each segment of the crack, wherein the accuracy is an intersection over length calculation based on the detection interval and the length of a respective segment of the manually labeled polylines.

The algorithm can then aggregate the value indicative of the accuracy of the model for that particular segment with other values for other respective segments to determine an overall accuracy of the model for the image. In some embodiments, the accuracy values can be weighted based on the length of the respective segments.

In some aspects, with appropriate modifications the presently disclosed IoL metric can be used to implement one or more loss functions for training (or re-training, etc.) a machine learning model, such as a thin-line segmentation model. For instance, the IoL metric can be used as a loss function either replacing one or more traditional loss functions for training the machine learning model (e.g., mIoU, Dice loss, etc.) and/or can be combined with one or more traditional loss functions for training the machine learning model. In one illustrative example, a machine learning model (e.g., thin-line segmentation model) can be trained using the presently disclosed IoL metric based on using the IoL-based loss to adjust one or more model intrinsic weights during the training process. In this manner, more accurate predictions are encouraged if the IoL-based loss decreases. Training can continue based on the one or more IoL-based loss functions for one or more rounds. Based on the IoL-based loss converging to a minimum value, the training can conclude.

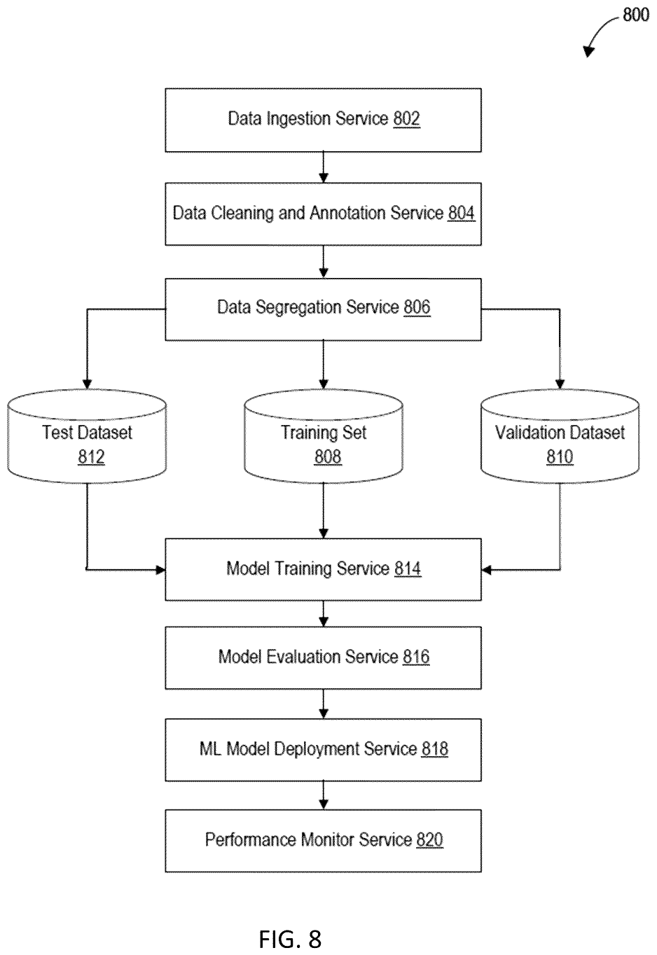

FIG. 8 illustrates an example lifecycle 800 of a ML model in accordance with some examples. The first stage of the lifecycle 800 of a ML model is a data ingestion service 802 to generate datasets described below. ML models require a significant amount of data for the various processes described in FIG. 8 and the data persisted without undertaking any transformation to have an immutable record of the original dataset. The data can be provided from third party sources such as publicly available dedicated datasets. The data ingestion service 802 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 802 retrieves the data. In some examples, the data ingestion service 802 may be online and the data is streamed from the producer in real-time for storage in the data ingestion service 802.

After data ingestion service 802, a data preprocessing service preprocesses the data to prepare the data for use in the lifecycle 800 and includes at least data cleaning, data transformation, and data selection operations. The data cleaning and annotation service 804 removes irrelevant data (data cleaning) and general preprocessing to transform the data into a usable form. The data cleaning and annotation service 804 includes labelling of features relevant to the ML model. In some examples, the data cleaning and annotation service 804 may be a semi-supervised process performed by a ML to clean and annotate data that is complemented with manual operations such as labeling of error scenarios, identification of untrained features, etc.

After the data cleaning and annotation service 804, data segregation service 806 to separate data into at least a training set 808, a validation dataset 810, and a test dataset 812. Each of the training set 808, a validation dataset 810, and a test dataset 812 are distinct and do not include any common data to ensure that evaluation of the ML model is isolated from the training of the ML model.

The training set 808 is provided to a model training service 814 that uses a supervisor to perform the training, or the initial fitting of parameters (e.g., weights of connections between neurons in artificial neural networks) of the ML model. The model training service 814 trains the ML model based a gradient descent or stochastic gradient descent to fit the ML model based on an input vector (or scalar) and a corresponding output vector (or scalar).

After training, the ML model is evaluated at a model evaluation service 816 using data from the validation dataset 810 and different evaluators to tune the hyperparameters of the ML model. The predictive performance of the ML model is evaluated based on predictions on the validation dataset 810 and iteratively tunes the hyperparameters based on the different evaluators until a best fit for the ML model is identified. After the best fit is identified, the test dataset 812, or holdout data set, is used as a final check to perform an unbiased measurement on the performance of the final ML model by the model evaluation service 816. In some cases, the final dataset that is used for the final unbiased measurement can be referred to as the validation dataset and the dataset used for hyperparameter tuning can be referred to as the test dataset.

After the ML model has been evaluated by the model evaluation service 816, an ML model deployment service 818 can deploy the ML model into an application or a suitable device. The deployment can be into a further test environment such as a simulation environment, or into another controlled environment to further test the ML model.

After deployment by the ML model deployment service 818, a performance monitor service 820 monitors for performance of the ML model. In some cases, the performance monitor service 820 can also record additional transaction data that can be ingested via the data ingestion service 802 to provide further data, additional scenarios, and further enhance the training of ML models.

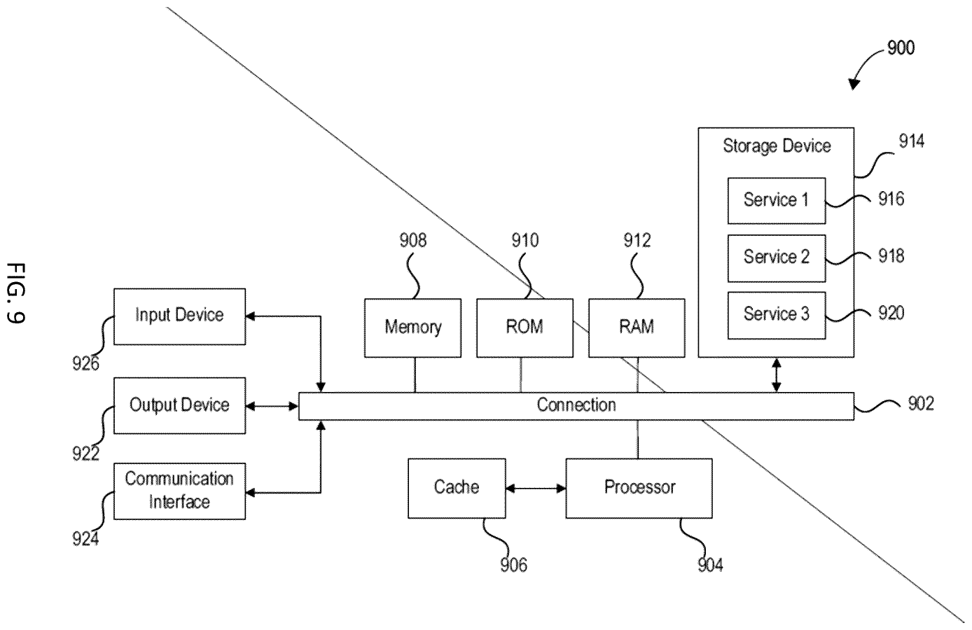

FIG. 9 shows an example of computing system 900, which can be for example any computing device making up a computing system configured to perform the above operations or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 910 and random access memory (RAM) 912 to processor 904. Computing system 900 can include a cache of high-speed memory 906 connected directly with, in close proximity to, or integrated as part of processor 904.

Processor 904 can include any general purpose processor and a hardware service or software service, such as services 916, 918, and 920 stored in storage device 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

1. A method comprising:
receiving a set of manually labeled polylines and a prediction mask produced by a model for an image, wherein the set of manually labeled polylines are associated with a general trend of a crack in the image, and wherein the prediction mask is associated with detection of the crack;
skeletonizing the prediction mask to obtain prediction polylines for the image;
augmenting the set of manually labeled polylines with a buffer along a length of the set of manually labeled polylines, wherein the buffer provides a tolerance region to compensate for imperfections in manual labels of the set of manually labeled polylines;
portraying the set of manually labeled polylines with the buffer as a ground truth graph, wherein each edge of the ground truth graph is a polyline and each node of the ground truth graph is a location where one or more polylines meet or diverge;
projecting each segment of the prediction polylines onto the ground truth graph;
determining detection intervals between the set of manually labeled polylines with the buffer and the prediction polylines, wherein the detection intervals are start and end points of projections of the prediction polylines onto the set of manually labeled polylines within the buffer; and
computing an accuracy of the model for each segment of the crack, wherein the accuracy is an intersection over length calculation based on the detection intervals and the length of a respective segment of the set of manually labeled polylines.

2. The method of claim 1, wherein augmenting the set of manually labeled polylines with the buffer comprises adding one or more pixels on one side of the set of manually labeled polylines, thereby increasing an area corresponding to a ground truth location of the crack associated with the set of manually labeled polylines.

3. The method of claim 1, wherein augmenting the set of manually labeled polylines with the buffer comprises adding one or more pixels on both sides of the set of manually labeled polylines.

4. The method of claim 1, wherein addition of one or more buffer pixels on either side of a polyline is based on a manually labeled polyline having a width of one pixel.

5. The method of claim 1, wherein a quantity of pixels added or buffered on either side of a manually labeled polyline to create a buffered polygonal area having a buffered area with a width is an integer multiple of a width of the manually labeled polyline itself.

6. The method of claim 5, wherein the width of the buffered area added on either side of a polyline is greater than the width of the manually labeled polyline itself.

7. The method of claim 5, wherein the width of the buffered area added on either side of a polyline is equal to the width of the manually labeled polyline itself.

8. The method of claim 5, wherein the buffered area is a same on both sides of the manually labeled polyline.

9. The method of claim 5, wherein the buffered area added adjacent to a first side of the manually labeled polyline is larger than the buffered area added adjacent to a second side of the manually labeled polyline.

10. The method of claim 5, wherein the buffered area added adjacent to a first side of the manually labeled polyline is smaller than the buffered area added adjacent to a second side of the manually labeled polyline.

11. The method of claim 1, wherein the set of manually labeled polylines of the ground truth graph are dissected into individual segments, such that each segment is an edge of a graph and each location where the crack either converges or diverges is a node of the ground truth graph.

12. The method of claim 1, further comprising: F
aggregating accuracy values indicative of accuracy of the model for a particular segment with other values for other respective segments to determine an overall accuracy of the model for the image.

13. The method of claim 12, wherein the accuracy values are weighted based on a length of the respective segments.

14. A device comprising:
a processor; and
a memory storing instructions, which when executed by the processor, cause the device to:
receive a set of manually labeled polylines and a prediction mask produced by a model for an image, wherein the set of manually labeled polylines are associated with a general trend of a crack in the image, and wherein the prediction mask is associated with detection of the crack;
skeletonize the prediction mask to obtain prediction polylines for the image;
augment the set of manually labeled polylines with a buffer along a length of the set of manually labeled polylines, wherein the buffer provides a tolerance region to compensate for imperfections in manual labels of the set of manually labeled polylines;
portray the set of manually labeled polylines with the buffer as a ground truth graph, wherein each edge of the ground truth graph is a polyline and each node of the ground truth graph is a location where one or more polylines meet or diverge;
project each segment of the prediction polylines onto the ground truth graph;
determine detection intervals between the set of manually labeled polylines with the buffer and the prediction polylines, wherein the detection intervals are start and end points of projections of the prediction polylines onto the set of manually labeled polylines within the buffer; and
compute an accuracy of the model for each segment of the crack, wherein the accuracy is an intersection over length calculation based on the detection intervals and the length of a respective segment of the set of manually labeled polylines.

15. (canceled)

16. The device of claim 14, wherein a quantity of pixels added or buffered on either side of a manually labeled polyline to create a buffered polygonal area having a buffered area with a width is an integer multiple of a width of the manually labeled polyline itself.

17. The device of claim 16, wherein the width of the buffered area added on either side of a polyline is greater than the width of the manually labeled polyline itself.

18. The device of claim 16, wherein the width of the buffered area added on either side of a polyline is equal to the width of the manually labeled polyline itself.

19. The device of claim 16, wherein the buffered area is a same on both sides of the manually labeled polyline.

20. The device of claim 16, wherein the buffered area added adjacent to a first side of the manually labeled polyline is larger than the buffered area added adjacent to a second side of the manually labeled polyline.

21. The device of claim 16, wherein the buffered area added adjacent to a first side of the manually labeled polyline is smaller than the buffered area added adjacent to a second side of the manually labeled polyline.
